(19) United States
(12) Patent Application Publication
(10) Pub. No.: US 2022/0311075 A1
(43) Pub. Date: Sep. 29, 2022

(54) BATTERY SYSTEM AND AIRCRAFT EQUIPPED WITH THE SAME

(71) Applicant: Honda Motor Co., Ltd., Tokyo (JP)

(72) Inventors: Tomoyo MATSUMOTO, Saitama (JP); Kenro UDONO, Saitama (JP)

(73) Assignee: Honda Motor Co., Ltd., Tokyo (JP)

(21) Appl. No.: 17/680,210

(22) Filed: Feb. 24, 2022

(30) Foreign Application Priority Data
Mar. 23, 2021 (JP) 2021-048242

(51) Int. Cl. H01M 10/6568; H01M 10/613; H01M 10/625

(52) U.S. Cl. CPC H01M 10/6568; H01M 10/613; H01M 10/625; H01M 2220/20

(57) ABSTRACT

According to the disclosure, a battery module can be sufficiently cooled in both a steady operation and an emergency operation. A battery system 32 includes a battery module 30 having a plurality of unit cells 40. The battery module 30 is individually provided with a first cooling part 36 through which a first cooling medium 62 flows, by which heat of the unit cells 40 in the battery module 30 is transferred. The unit cells 40 in the battery module 30 are simultaneously cooled by the first cooling part. The battery system 32 includes a second cooling part 78 that discharges a second cooling medium 80 into a casing 34 that houses the battery module 30. The battery module 30 in the casing 34 is simultaneously cooled by the second cooling part.

### CROSS-REFERENCE TO RELATED APPLICATION

This application claims the priority benefits of Japanese application no. 2021-048242, filed on Mar. 23, 2021. The entirety of the above-mentioned patent application is hereby incorporated by reference herein and made a part of this specification.

### BACKGROUND

### Technical Field

The disclosure relates to a battery system having a plurality of battery modules and an aircraft equipped with the battery system.

### Description of Related Art

An electric multicopter equipped with a battery pack is known as a kind of aircraft. In this case, the multicopter is provided with lift generators such as propellers or ducted fans. Further, the airframe is equipped with a motor for rotating the lift generator, and the battery pack for supplying electric power to the motor. In some cases, an additional generator may be installed to supply electric power to the battery pack and the motor. Then, the battery pack is discharged or charged by the generator according to the flight state of the multicopter. The battery pack is configured by electrically connecting a plurality of battery modules housed in one casing.

During charging and discharging, the temperature of the unit cells in the battery module rises and the unit cells become hot. In order to prevent the temperature of the unit cells from rising excessively, the heat is removed from the unit cells as much as possible. For example, according to the technique described in Patent Document 1, a heat storage part is provided between adjacent unit cell rows, and the heat of the unit cells is absorbed by the heat storage part. The heat absorbed by the heat storage part is released to the outside via a cooling passage.

Furthermore, Patent Documents 2 and 3 describe configurations for supplying cooling water to the cells in an emergency.

### RELATED ART

### Patent Documents

[Patent Document 1] Japanese Laid-Open No. 2014-103005
[Patent Document 2] Japanese Laid-Open No. 2013-171625
[Patent Document 3] Japanese Laid-Open No. 2002-8737

It is assumed that the power supply required for the battery pack increases when the multicopter makes an emergency landing. In this case, the individual unit cells become even hotter. With the configurations disclosed in Patent Documents 1 to 3, it is difficult to cope with such suddenly increasing heat (high temperature) of the unit cells.

### SUMMARY

According to an embodiment of the disclosure, a battery system is provided, including: a battery module having a plurality of unit cells; and a casing housing a plurality of the battery modules. The battery module individually has a first cooling part through which a first cooling medium flows, and heat of the plurality of unit cells in the battery module is transferred by the first cooling medium. The battery system has a second cooling part which discharges a second cooling medium into the casing. The second cooling part includes a storage container storing the second cooling medium, and a supply mechanism supplying the second cooling medium from the storage container to the casing. The first cooling part simultaneously cools the plurality of unit cells in one battery module. The second cooling part simultaneously cools the plurality of battery modules. An aircraft equipped with the same is also provided.

### BRIEF DESCRIPTION OF THE DRAWINGS

FIG. 1 is a schematic perspective view of an aircraft (multicopter) according to an embodiment of the disclosure.

FIG. 2 is a schematic side view schematically showing main parts of a battery system.

FIG. 3 is a schematic front view of a battery module constituting the battery system.

FIG. 4 is a schematic overall front view of a unit cell.

FIG. 5 is a schematic overall front view showing the shape of a heat conductive member together with the unit cell and a cooling jacket.

FIG. 6 is a schematic overall front view showing a heat conductive member having a different shape and a cooling jacket in a different position from FIG. 5 together with a unit cell.

### DESCRIPTION OF THE EMBODIMENTS

The disclosure provides a battery system that can remove heat from individual unit cells in both a steady operation and an emergency operation and therefore can prevent the temperature of the unit cells and thus the battery module from rising excessively, and an aircraft equipped with the battery system.

According to an embodiment of the disclosure, a battery system is provided, including: a battery module having a plurality of unit cells; and a casing housing a plurality of the battery modules. The battery module individually has a first cooling part through which a first cooling medium flows, and heat of the plurality of unit cells in the battery module is transferred by the first cooling medium. The battery system has a second cooling part which discharges a second cooling medium into the casing. The second cooling part includes a storage container storing the second cooling medium, and a supply mechanism supplying the second cooling medium from the storage container to the casing. The first cooling part simultaneously cools the plurality of unit cells in one battery module. The second cooling part simultaneously cools the plurality of battery modules. An aircraft equipped with the same is also provided.

According to the disclosure, the first cooling part for removing the heat of the unit cell and the second cooling part for removing the heat of the battery module are provided. According to this configuration, it is possible to remove excess heat by the second cooling part even in a situation where the heat is not sufficiently removed by the first cooling part. Accordingly, for example, the cooling capacity of the first cooling part may be designed to such an extent that heat can be sufficiently removed from the unit cell during a steady operation, in which the required electric power is substantially constant. Then, in the case of an emergency operation, in which the required electric power suddenly increases, the excess heat may be removed by the second cooling part.

Thus, it is possible to remove heat from individual unit cells in both a steady operation and an emergency operation. Therefore, it is possible to prevent the temperature of the unit cell and thus the battery pack constituting the battery system from rising excessively without providing a large-scale cooling facility.

Therefore, when the above-described battery module is mounted on an aircraft, the flexibility in the device layout is improved. Further, since it is not required to install a large-scale cooling facility, the total weight of the aircraft can be reduced. The power consumption can also be reduced.

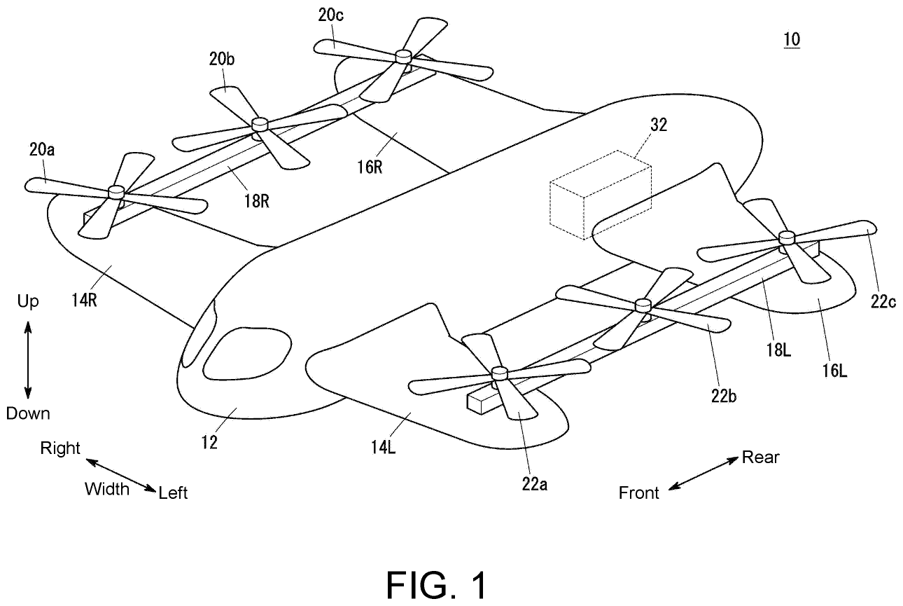

Hereinafter, a battery system according to the disclosure will be described in detail with reference to the accompanying drawings based on suitable embodiments in relation to an aircraft equipped with the battery system. In the following, “front” and “rear” refer to the front and rear in a flight direction of the aircraft (multicopter 10 shown in FIG. 1). In addition, “down” and “up” are directions facing the lower side and the upper side of the aircraft. Further, “left” and “right” indicate the left and right when the front is visually recognized from the inside of the aircraft. The “width direction” is synonymous with “left-right direction”.

FIG. 1 is a schematic perspective view of the multicopter 10 that serves as the aircraft according to the present embodiment. The multicopter 10 includes an airframe 12, a right main wing 14R and a left main wing 14L that project from the front side of the airframe 12 and extend in the width direction, and a right horizontal stabilizer 16R and a left horizontal stabilizer 16L that project from the rear side of the airframe 12 and extend in the width direction. Further, a right support bar 18R is bridged from the right main wing 14R to the right horizontal stabilizer 16R, and a left support bar 18L is bridged from the left main wing 14L to the left horizontal stabilizer 16L.

Propellers 20a to 20c are provided on the right main wing 14R, the right support bar 18R, and the right horizontal stabilizer 16R, respectively. Propellers 22a to 22c are provided on the left main wing 14L, the left support bar 18L, and the left horizontal stabilizer 16L, respectively. The six propellers 20a to 20c and 22a to 22c are lift generators. That is, the multicopter 10 can take off or fly in the air under the action of the six propellers 20a to 20c and 22a to 22c.

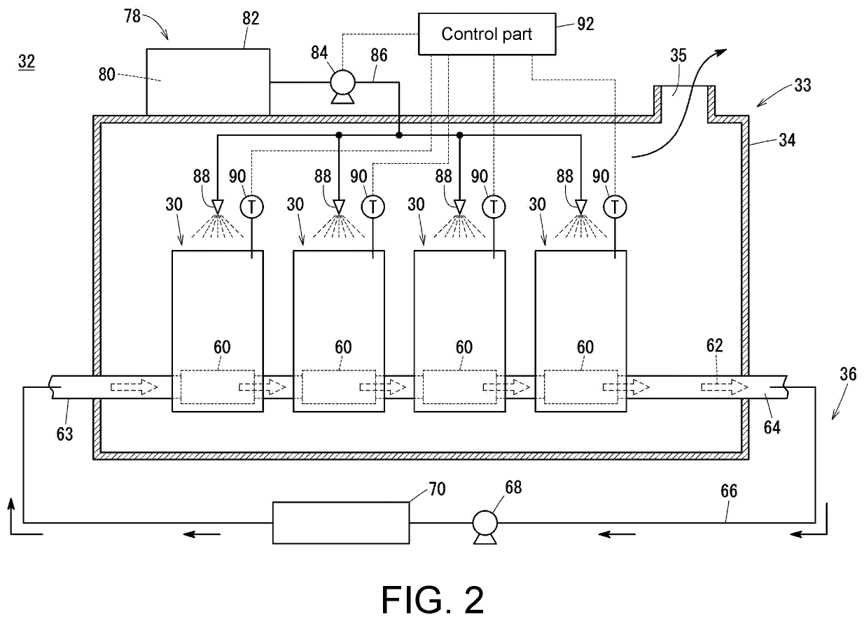

The airframe 12 is equipped with the same number of motors (not shown) as the propellers 20a to 20c and 22a to 22c, and a battery system 32 including battery modules 30 shown in FIG. 2. The rotor blades of the propellers 20a to 20c and 22a to 22c are individually connected to the rotation shafts of the motors. When electric power is supplied to the motor from a battery pack 33 (see FIG. 2) that constitutes the battery system 32, the motor is energized. Thereby, the rotation shaft rotates, and the rotor blades rotate integrally with the rotation shaft. As the propellers 20a to 20c and 22a to 22c are energized in this way, the multicopter 10 can take off or fly in the air.

The battery system 32 will be described with reference to FIG. 2. The battery system 32 includes a battery pack 33 configured by housing a plurality of (for example, about 20) battery modules 30 in a casing 34, and a circulation supply mechanism 36 serving as a first cooling part. The casing 34 is provided with a vent duct 35.

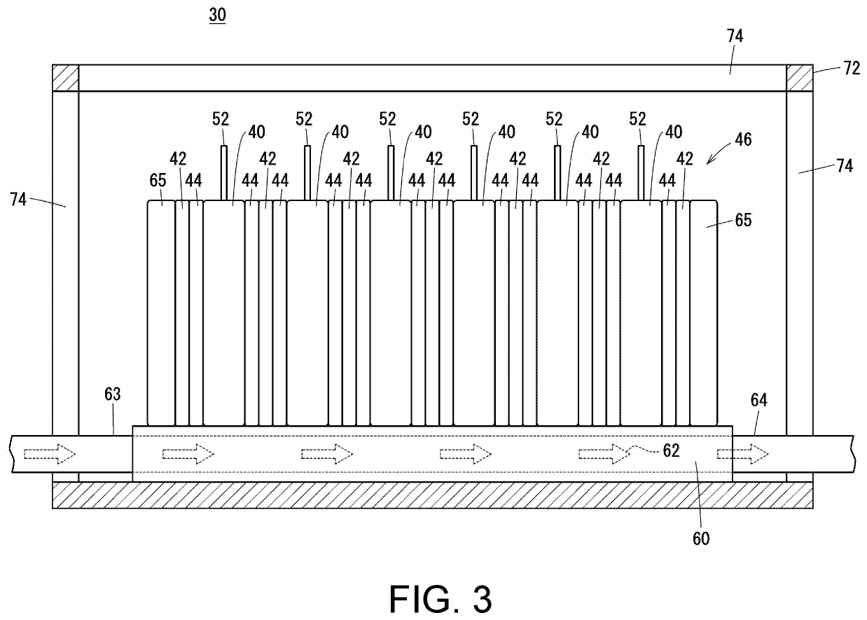

As shown in FIG. 3, each of the battery modules 30 has a plurality of unit cells 40 and a heat storage member 42 interposed between adjacent unit cells 40. Further, a heat conductive member 44 is interposed between the heat storage member 42 and the unit cell 40. That is, the unit cell 40, the heat conductive member 44, and the heat storage member 42 are repeatedly arranged in parallel in this order, thereby forming a laminated body 46. It is not particularly necessary to arrange the heat conductive member 44 on both end surfaces of the unit cell 40, and the heat conductive member 44 may be arranged on only one end surface side. It is also possible to provide the laminated body without using the heat conductive member 44.

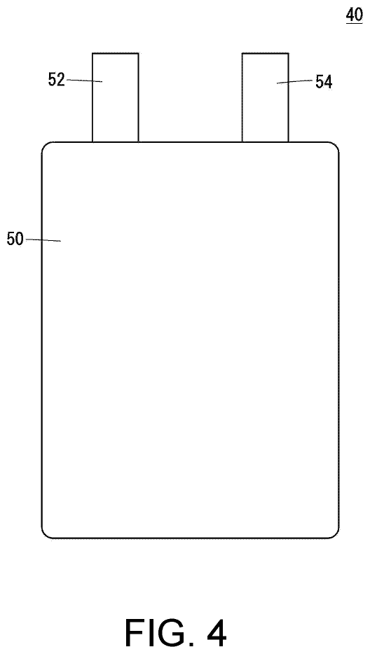

The unit cell 40 is composed of, for example, a lithium ion battery, and as shown in FIG. 4, the unit cell 40 has a main body 50 having a substantially quadrangular shape, and a positive electrode terminal 52 and a negative electrode terminal 54 projecting in a tab shape from the main body 50. The positive electrode terminal 52 and the negative electrode terminal 54 project from one end portion of the main body 50, and in this case, are oriented and extend upward. In the laminated body 46, the positive electrode terminal 52 and the negative electrode terminal 54 project upward from the upper ends of the heat storage member 42 and the heat conductive member 44.

The heat storage member 42 can absorb and store the heat generated in the unit cell 40. A suitable example of the heat storage member 42 is a latent heat storage material (PCM). In this case, the heat storage member 42 is housed in an outer shell, and receives a certain amount of heat from the unit cell 40 and melts when the temperature rises. The latent heat storage material absorbs the amount of heat of the latent heat from the unit cell 40 when melting.

Moreover, suitable examples of the heat conductive member 44 include a graphite sheet, a heat transfer plate made of copper, a copper alloy, aluminum, an aluminum alloy or the like.

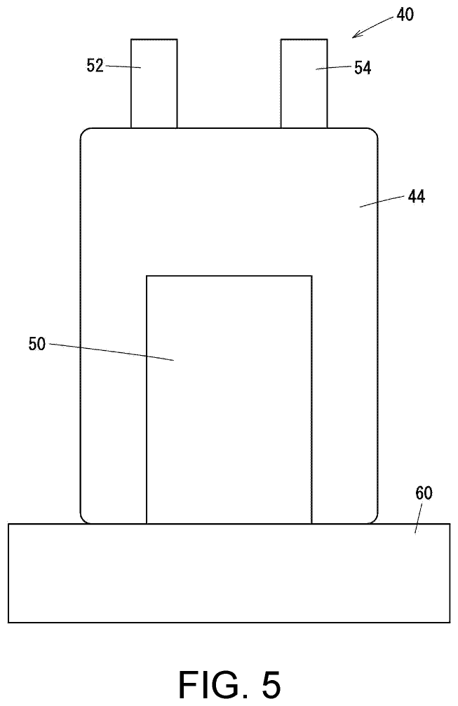

In the unit cell 40, the temperature is high on the upper end portion side where the positive electrode terminal 52 and the negative electrode terminal 54 project. On the other hand, the lower end portion side close to a cooling jacket 60 (which will be described later) has a relatively low temperature. Therefore, as shown in FIG. 5, the lower portion of the heat conductive member 44 may be cut out. In this case, since the heat conductive member 44 is lightweight, the weight of the battery module 30 and thus the battery system 32 can be reduced.

Below the laminated body 46, the circulation supply mechanism 36 is configured, and the cooling jacket 60 through which a first cooling medium 62 flows is arranged inside. A refrigerant inlet pipe 63 and a refrigerant outlet pipe 64 extend from the cooling jacket 60. The refrigerant outlet pipe 64 therein is connected to the refrigerant inlet pipe 63 of another battery module 30. That is, the first cooling medium 62 supplied to any one battery module 30 flows in the cooling jacket 60 constituting the battery module 30, and then moves to the cooling jacket 60 constituting another battery module 30 and flows in the cooling jacket 60.

Support walls 65 are erected on the upper surface of the cooling jacket 60 so as to face each other. The laminated body 46 is sandwiched between the support walls 65 to maintain an upright position.

As shown in FIG. 2, the circulation supply mechanism 36 includes a circulation supply pipe 66 for circulating and supplying the first cooling medium 62 to the cooling jacket 60. Specifically, the circulation supply pipe 66 is connected to the refrigerant inlet pipe 63 of the cooling jacket 60, which is the first in the flow order of the first cooling medium 62, and the refrigerant outlet pipe 64 of the cooling jacket 60, which is the last. A circulation pump 68 and a cooling heat exchanger 70 are interposed in the circulation supply pipe 66, and the first cooling medium 62 is sent out from the circulation supply pipe 66 to the refrigerant inlet pipe 63 by the circulation pump 68, and returns to the circulation supply pipe 66 via the refrigerant outlet pipe 64. The first cooling medium 62 returned to the circulation supply pipe 66 is cooled by the atmosphere in contact with the cooling heat exchanger 70 while flowing through the cooling heat exchanger 70, for example. After cooling, the first cooling medium 62 is resupplied to the cooling jacket 60. When the battery module 30 (or the battery pack 33) is at a high temperature and it is required to protect the unit cell 40 and the battery module 30, the first cooling medium 62 is circulated and supplied to the cooling jacket 60 in this way.

The laminated body 46 and the cooling jacket 60 are housed in a hollow square tubular module case 72 shown in FIG. 3. Thereby, the battery module 30 is configured. An opening 74 is formed on each end surface of the module case 72 to prevent heat from being trapped inside. Of course, the module case 72 is positioned and fixed to the inner wall (for example, the bottom wall) of the casing 34 via bolts or the like.

The battery system 32 further includes a refrigerant discharge mechanism 78 serving as a second cooling part. The refrigerant discharge mechanism 78 has a storage container 82 storing a second cooling medium 80, and a supply pump 84 for supplying the second cooling medium 80 in the storage container 82 into the casing 34. A liquid transfer pipe 86 is routed from the storage container 82 to the casing 34, and the supply pump 84 is provided in the liquid transfer pipe 86. The tip of the liquid transfer pipe 86 inserted into the casing 34 is branched corresponding to the number of the battery modules 30 to form branches. Each branch is arranged above each battery module 30 and is provided with a diffusion nozzle 88.

Each battery module 30 is provided with a temperature sensor 90. The temperature information obtained by the temperature sensor 90 is sent to a control part 92. That is, the control part 92 constantly monitors the temperature of the battery module 30. Further, the control part 92 controls ON/OFF of the supply pump 84. In other words, the supply pump 84 is switched from an energized state to a de-energized state under the control action of the control part 92, and vice versa.

In the above configuration, suitable examples of the first cooling medium 62 include water, oil or the like, or the first cooling medium 62 may be ethylene glycol, ammonia or the like. On the other hand, a suitable example of the second cooling medium 80 is a fluoroketone.

The battery system 32 according to the present embodiment is basically configured as described above, and the operation and effect thereof will be described next.

The multicopter 10 shown in FIG. 1 can take off and fly by energizing the motors supplied with the electric power from the battery pack 33. That is, as the rotation shafts of the motors rotate, the rotor blades of the propellers 20a to 20c and 22a to 22c rotate following the rotation shafts, which creates lift that raises or flies the multicopter 10. Further, the circulation pump 68 is energized, and the first cooling medium 62 is sequentially supplied to the cooling jacket 60 of each battery module 30 from the circulation supply pipe 66 and the refrigerant inlet pipe 63. The cooling medium returns to the circulation supply pipe 66 via the refrigerant outlet pipe 64.

High output is required for the motor during takeoff and landing. Therefore, a large amount of power supply is required for the battery pack 33. That is, the required electric power becomes large, and a large current is discharged from the unit cell 40. Furthermore, in a case where the multicopter 10 is equipped with a generator, surplus electric power is generated when the output of the motor is small. The surplus electric power is used to charge the unit cell 40.

Due to the discharging and charging, the unit cell 40 becomes hot. Most of the heat is transferred to the cooling jacket 60 of each battery modules 30 via the heat conductive member 44. As described above, the first cooling medium 62 is circulated in the cooling jacket 60. Accordingly, the heat of all the unit cells 40 in the individual battery modules 30 is quickly and simultaneously removed. In some cases, the heat storage member 42 also contributes to the removal of heat from the unit cell 40.

When the multicopter 10 changes from steady flight to emergency landing for some reason, a large output is required of the battery pack 33 in order to increase the output of the motors to rotate the rotor blades of the propellers 20a to 20c and 22a to 22c at a high speed. In order to cope with this, a large amount of electric power is supplied to the motors from the battery pack 33. Consequently, the amount of heat generated in the unit cell 40 further increases so the temperature of the battery module 30 rises. Even under this circumstance, the heat of the unit cell 40 is quickly transferred to the cooling jacket 60 via the heat conductive member 44, as in the case of a steady operation, and the heat is quickly removed by the first cooling medium 62 that is circulated and supplied into the cooling jacket 60.

When the amount of heat generated in the unit cell 40 still increases, the heat storage member 42 absorbs the increase in the amount of heat. Since the heat storage member 42 absorbs a sufficient amount of heat from the unit cell 40, the temperature rise of the unit cell 40 is suppressed. That is, the temperature rise of the unit cell 40 can be slowed down by the first cooling medium 62 and the heat storage member 42.

As described above, the control part 92 constantly monitors the temperature of each battery module 30. Then, the control part 92 determines whether or not the temperature of each battery module 30 exceeds a predetermined value. When the temperature of each battery module 30 is equal to or lower than the predetermined value, the control part 92 keeps the supply pump 84 in the de-energized state. Accordingly, the second cooling medium 80 in the storage container 82 is not supplied into the casing 34.

On the other hand, when the temperature of each battery module 30 exceeds the predetermined value for the heat generated in the unit cell 40 cannot be absorbed by the heat storage member 42, the control part 92 determines that “emergency cooling of the battery module 30 is necessary”. Based on this determination, the control part 92 issues a command signal of “energizing the supply pump 84” to the supply pump 84. The supply pump 84 is energized by this command signal. As a result, the second cooling medium 80 in the storage container 82 is sucked under the action of the supply pump 84, and moves in the liquid transfer pipe 86 toward the side of the casing 34. The second cooling medium 80 is diffused from the diffusion nozzle 88 into the casing 34. At this time, the second cooling medium 80 may be in the form of a liquid or a mist.

Since the branches at the tip of the liquid transfer pipe 86 are provided corresponding to the number of the battery modules 30, the second cooling medium 80 diffused into the casing 34 wets all the battery modules 30. Because the second cooling medium 80 adhering to the battery modules 30 has a low temperature, the heat of the battery modules 30 is taken by the second cooling medium 80. In some cases, the second cooling medium 80 takes the amount of heat of the latent heat from the battery modules 30 and evaporates. For the above reasons, all the battery modules 30 in the casing 34 are cooled quickly and simultaneously.

Thus, in the present embodiment, when the temperature of the battery module 30 rises excessively during an emergency operation, the battery module 30 is cooled by the refrigerant discharge mechanism 78, which is the second cooling part. Accordingly, even when a large amount of electric power is required, it is still possible to prevent the temperature of the unit cell 40 and thus the battery module 30 from further rising. In addition, the battery module 30 can be returned to a temperature at which the deterioration of the unit cell 40 can be avoided.

That is, according to the present embodiment, the heat can be removed from the unit cell 40 or the battery module 30 in both the steady operation and the emergency operation. Accordingly, it is not particularly required to further add a redundant cooling facility to the battery pack 33. Therefore, it is possible to simplify the related equipment of the battery pack 33. Therefore, the flexibility in the device layout in the multicopter 10 is improved. Furthermore, there are advantages that the total weight of the multicopter 10 is reduced and the power consumption is also reduced.

Moreover, the refrigerant discharge mechanism 78 operates only when the temperature exceeds the predetermined value. Accordingly, the unit cell 40 is prevented from being excessively cooled during the steady operation of the multicopter 10.

When the second cooling medium 80 evaporates into a gas phase, the second cooling medium 80 in the gas phase is discharged from the vent duct 35 to the outside of the casing 34. Therefore, the pressure in the casing 34 is prevented from being raised by the second cooling medium 80 in the gas phase.

When the temperature of the battery module 30 drops and falls far below the predetermined value, the supply of the second cooling medium 80 may be stopped under the control action of the control part 92. That is, at this time, the supply pump 84 may be de-energized by the control part 92.

The disclosure is not particularly limited to the above-described embodiments, and various modifications can be made without departing from the gist of the disclosure.

For example, the battery system 32 is not necessarily mounted on an aircraft such as the multicopter 10 and may also be mounted on a land-based vehicle such as a four-wheeled vehicle or a two-wheeled vehicle, or a water-based operating body such as a ship. Further, the battery system 32 may be of a so-called stationary type.

Further, in the present embodiment, the supply pump 84 is energized or de-energized according to the temperature of the battery module 30, but an on-off valve may be provided in the liquid transfer pipe 86, and the on-off valve may be opened or closed according to the temperature of the battery module 30. In this case, the supply pump 84 may be constantly energized, or may be energized or de-energized according to the opening or closing of the on-off valve.

Furthermore, a vent may be opened or closed by the control part 92, or may be automatically opened or closed when the pressure in the casing 34 reaches a predetermined pressure.

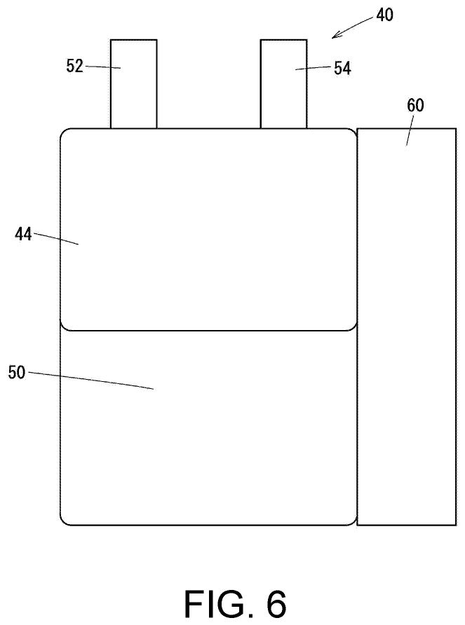

Then, as shown in FIG. 6, the cooling jacket 60 may be in an upright position. In this case, the heat conductive member 44 may have an outer dimension that is in contact with only the upper end portion of the unit cell 40.

In either case, the unit cell 40 may be in a lying position with the positive electrode terminal 52 and the negative electrode terminal 54 facing in the width direction of the aircraft.

What is claimed is:

1. A battery system, comprising:
a battery module having a plurality of unit cells; and
a casing housing a plurality of the battery modules,
wherein the battery module individually has a first cooling part through which a first cooling medium flows, and heat of the plurality of unit cells in the battery module is transferred by the first cooling medium,
the battery system has a second cooling part which discharges a second cooling medium into the casing,
the second cooling part comprises a storage container storing the second cooling medium, and a supply mechanism supplying the second cooling medium from the storage container to the casing,
the first cooling part simultaneously cools the plurality of unit cells in one battery module, and
the second cooling part simultaneously cools the plurality of battery modules.

2. The battery system according to claim 1, comprising a circulation supply mechanism for constantly circulating and supplying the first cooling medium while the battery system is in operation, wherein the supply mechanism discharges the second cooling medium into the casing when an instruction is issued from a control part.

3. The battery system according to claim 2, wherein the control part issues the instruction to discharge the second cooling medium when a temperature of the battery module exceeds a preset predetermined value.

4. The battery system according to claim 1, wherein the battery module comprises a heat storage member interposed between the unit cells adjacent to each other.

5. The battery system according to claim 2, wherein the battery module comprises a heat storage member interposed between the unit cells adjacent to each other.

6. The battery system according to claim 3, wherein the battery module comprises a heat storage member interposed between the unit cells adjacent to each other.

7. The battery system according to claim 4, wherein the battery module comprises a heat conductive member interposed between the unit cell and the heat storage member.

8. The battery system according to claim 5, wherein the battery module comprises a heat conductive member interposed between the unit cell and the heat storage member.

9. The battery system according to claim 6, wherein the battery module comprises a heat conductive member interposed between the unit cell and the heat storage member.

10. An aircraft equipped with the battery system according to claim 1.
